(19) United States
(12) Patent Application Publication
(10) Pub. No.: US 2023/0252479 A1
(43) Pub. Date: Aug. 10, 2023

(54) METHOD OF AUTOMATICALLY DETECTING ABNORMAL TRANSACTIONS ONLINE

(71) Applicant: S2W INC., Seongnam-si (KR)

(72) Inventors: So Young Chae, Yongin-si (KR); Ki Cheol Kim, Seongnam-si (KR); In Wook Hwang, Seongnam-si (KR)

(73) Assignee: S2W INC., Seongnam-si (KR)

(21) Appl. No.: 17/842,307

(22) Filed: Jun. 16, 2022

(30) Foreign Application Priority Data
Feb. 9, 2022 (KR) 10-2022-0017052

(51) Int. Cl. G06Q 20/40; G06Q 30/02

(52) U.S. Cl. CPC G06Q 20/4016; G06Q 30/0201

(57) ABSTRACT

The present disclosure relates to a method of automatically detecting, by an electronic device, an abnormal transaction. The method may include: acquiring transaction information from an e-commerce server, the transaction information including unique information that is difficult for a user to arbitrarily change, arbitrary information that a user changes arbitrarily, and an access Internet protocol (IP) address; extracting a first identifier based on the unique information; extracting a plurality of second identifiers based on the arbitrary information; generating a third identifier based on the plurality of second identifiers; generating a first node based on the first identifier, and generating a second node based on the third identifier; generating a third node based on the access IP address; and connecting the first node, the second node, and the third node to generate an identity map for automatically detecting the abnormal transaction.

### CROSS-REFERENCE TO RELATED APPLICATION

This application claims priority to and the benefit of Korean Patent Application No. 10-2022-0017052, filed on Feb. 9, 2022, the disclosure of which is incorporated herein by reference in its entirety.

### BACKGROUND

### 1. Field of the Invention

The present disclosure relates to a method and apparatus for automatically detecting an abnormal transaction online.

### 2. Discussion of Related Art

As the size of the online market grows, attempts to obtain financial gains by attempting abnormal transactions, such as price manipulation or cross trading, in stocks and securities, resell platforms, virtual currency transactions, and the like in addition to electronic commerce (e-commerce) are increasing.

Since such abnormal transaction may damage brand reputations of companies and cause disadvantages to consumers, the need to detect abnormal transactions online is increasing.

However, users who attempt abnormal transactions online often create multiple accounts so that they are not detected, and conclude transactions within a short time interval when attempting abnormal transactions so that they are not exposed to the risk of price fluctuations.

### SUMMARY OF THE INVENTION

The present disclosure is directed to configuring a method and apparatus for automatically detecting an abnormal transaction by detecting accounts expected to be the same through a user's access Internet protocol (IP) address pattern.

In addition, the present disclosure is directed to configuring a method and apparatus for automatically detecting an abnormal transaction by analyzing a transaction pattern such as a transaction conclusion time and a transaction proportion.

Objects to be achieved by the present disclosure are not limited to the above-described objects, and other objects that are not described may be obviously understood by those skilled in the art to which the present disclosure pertains from the following detailed description.

According to an aspect of the present disclosure, there is provided a method of automatically detecting, by an electronic device, an abnormal transaction, the method including: acquiring transaction information from an e-commerce server, the transaction information including unique information that is difficult for a user to arbitrarily change, arbitrary information that a user changes arbitrarily, and an access IP address; extracting a first identifier based on the unique information; extracting a plurality of second identifiers based on the arbitrary information; generating a third identifier based on the plurality of second identifiers; generating a first node based on the first identifier and generating a second node based on the third identifier; generating a third node based on the access IP address; and connecting the first node, the second node, and the third node to generate an identity map for automatically detecting the abnormal transaction.

The method may further include classifying a cluster based on the identity map, in which the cluster may include a set of connected nodes.

The method may further include detecting the abnormal transaction based on the cluster.

The detecting of the abnormal transaction based on the cluster may include determining the abnormal transaction when different first nodes connected to the third node are present.

The detecting of the abnormal transaction based on the cluster may include: monitoring a user's access history through the e-commerce server; and generating history data for each access IP address based on the monitoring result and the cluster, in which the history data may include an identifier of the user and an access time of the user.

The detecting of the abnormal transaction based on the cluster may further include determining the abnormal transaction when the number of transactions between the different first nodes is greater than or equal to a specific ratio of the number of individual transactions.

According to another aspect of the present disclosure, there is provided an electronic device for automatically detecting an abnormal transaction, the electronic device including: a communication module; a memory; and a processor that functionally controls the communication module and the memory, in which the processor may acquire transaction information from an e-commerce server, in which the transaction information includes unique information that is difficult for a user to arbitrarily change, arbitrary information that a user changes arbitrarily, and an access IP address, extract a first identifier based on the unique information, extract a plurality of second identifiers based on the arbitrary information, generate a third identifier based on the plurality of second identifiers, generate a first node based on the first identifier and generate a second node based on the third identifier, generate a third node based on the access IP address, and connect the first node, the second node, and the third node to generate an identity map for automatically detecting the abnormal transaction.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram for describing an electronic device according to the present disclosure;

FIG. 2 is an example of a method of constructing an identity map used in a method of detecting an abnormal transaction applicable to the present disclosure;

FIG. 3 is a flowchart for describing the method of detecting an abnormal transaction applicable to the present specification;

FIG. 4 is an example of an identity map applicable to the present disclosure;

FIG. 5 is an example of an access Internet protocol (IP) address pattern applicable to the present disclosure;

FIGS. 6A, 6B and 6C show examples of an automatic detection algorithm to which the present disclosure may be applied;

FIG. 7 is an example of a transaction conclusion time analysis to which the present disclosure may be applied; and

FIG. 8 is an embodiment of an electronic device to which the present disclosure may be applied.

The accompanying drawings, which are included as part of the detailed description to assist with understanding of the present disclosure, illustrate embodiments of the present disclosure and explain the technical features of the present disclosure together with the detailed description.

DETAILED DESCRIPTION OF EXEMPLARY EMBODIMENTS

Hereinafter, embodiments of the present disclosure will be described in detail with reference to the accompanying drawings. The same or similar components will be denoted by the same reference numerals throughout the drawings, and overlapping description of the same or similar components will be omitted. The terms “module” and “unit” for components used in the following description are used only to simplify the disclosure. Therefore, these terms do not have meanings or roles that are distinguished from each other in themselves. Further, when it is decided that detailed description of the known art related to the present disclosure may obscure the gist of the present disclosure, such detailed description will be omitted. Further, it should be understood that the accompanying drawings are provided only in order to allow exemplary embodiments of the present disclosure to be easily understood, and the spirit of the present disclosure is not limited by the accompanying drawings, but includes all the modifications, equivalents, and substitutions included in the spirit and the scope of the present disclosure.

Terms including ordinal numbers such as “first,” “second,” and the like may be used to describe various components. However, these components are not limited by these terms. The terms are used only to distinguish one component from another component.

It is to be understood that when one component is referred to as being “connected to” or “coupled to” another component, the one component may be connected directly to or coupled directly to another component or may be connected to or coupled to another component with still another component interposed therebetween. On the other hand, it should be understood that when one element is referred to as being “connected directly to” or “coupled directly to” another element, it may be connected to or coupled to another element with no other element interposed therebetween.

Singular forms are intended to include plural forms unless the context clearly indicates otherwise.

It will be further understood that the terms “include” or “have” used in the present disclosure specify the presence of features, numerals, steps, operations, components, parts described in the present disclosure, or combinations thereof, but do not preclude the presence or addition of one or more other features, numerals, steps, operations, components, parts, or combinations thereof.

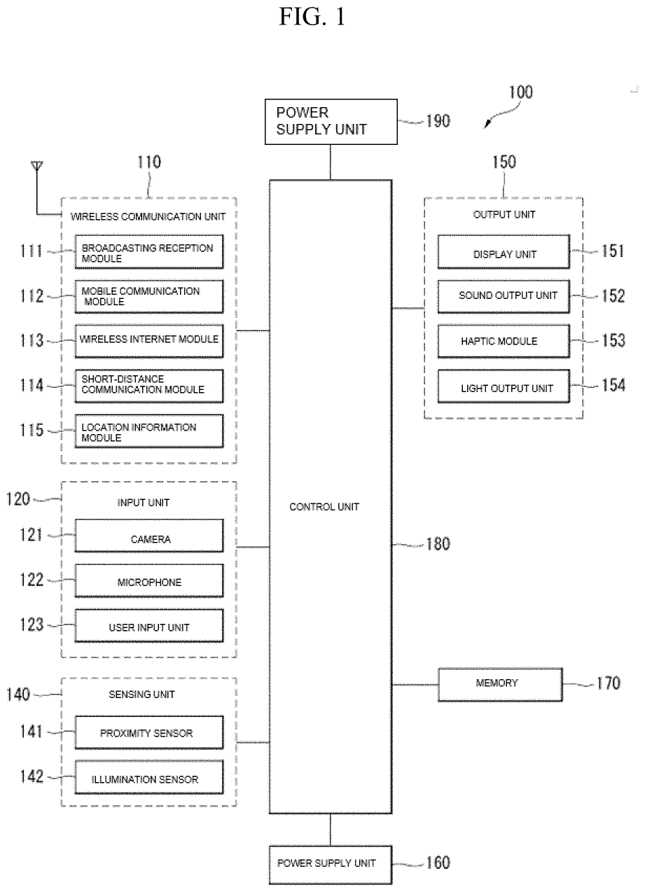

FIG. 1 is a block diagram for describing an electronic device according to the present disclosure.

The electronic device 100 includes a wireless communication unit 110, an input unit 120, a sensing unit 140, an output unit 150, an interface unit 160, a memory 170, a control unit 180, a power supply unit 190, and the like. The components illustrated in FIG. 1 are not essential to implementing the electronic device, and the electronic device described herein may have more or fewer components than those listed above.

More specifically, the wireless communication unit 110 of the components may include one or more modules which enable wireless communication between the electronic device 100 and a wireless communication system, between the electronic device 100 and other electronic devices 100, or between the electronic device 100 and an external server. In addition, the wireless communication unit 110 may include one or more modules which connect the electronic device 100 to one or more networks.

The wireless communication unit 110 may include at least one of a broadcast receiving module 111, a mobile communication module 112, a wireless Internet module 113, a short range communication module 114, and a location information module 115.

The input unit 120 may include a camera 121 or an image input unit for inputting an image signal, a microphone 122 for inputting a sound signal, an audio input unit, or a user input unit 123 (for example, a touch key, a mechanical key, or the like) for receiving information from a user. Voice data or image data collected by the input unit 120 may be analyzed and processed as a control command of a user.

The sensing unit 140 may include one or more sensors for sensing at least one of information in the electronic device, surrounding environment information around the electronic device, and user information. For example, the sensing unit 140 may include at least one of a proximity sensor 141, an illumination sensor 142, a touch sensor, an acceleration sensor, a magnetic sensor, a gravity sensor (G-sensor), a gyroscope sensor, a motion sensor, a red-green-blue (RGB) sensor, an infrared sensor (IR sensor), a finger scan sensor, an ultrasonic sensor, an optical sensor (for example, a camera (see 121)), a microphone (see 122), a battery gauge, an environmental sensor (for example, a barometer, a hygrometer, a thermometer, a radiation detection sensor, a heat detection sensor, a gas detection sensor, and the like), and a chemical sensor (for example, an electronic nose, a healthcare sensor, a biometric sensor, and the like). Meanwhile, the electronic device disclosed herein may use a combination of information sensed by at least two or more of these sensors.

The output unit 150 is used to generate an output related to the sense of vision, the sense of hearing, the sense of touch, or the like, and may include at least one of a display unit 151, a sound output unit 152, a haptic module 153, and an optical output unit 154. The display unit 151 may form a layer structure with the touch sensor or may be integrally formed with the touch sensor, thereby implementing a touch screen. The touch screen may function as the user input unit 123 which provides an input interface between the electronic device 100 and the user, and may provide an output interface between the electronic device 100 and the user.

The interface unit 160 serves as a path of various types of external devices connected to the electronic device 100. The interface unit 160 may include at least one of a wired/wireless headset port, an external charger port, a wired/wireless data port, a memory card port, a port for connection of a device including an identity module, an audio input/output (I/O) port, a video input/output (I/O) port, and an earphone port. The electronic device 100 may perform appropriate control related to the connected external device in response to the connection of the external device to the interface unit 160.

In addition, the memory 170 stores data supporting various functions of the electronic device 100. The memory 170 may store a plurality of application programs (or applications) that are driven by the electronic device 100, and data and instructions for operating the electronic device 100. At least some of these application programs may be downloaded from the external server via the wireless communication. In addition, at least some of these application programs may exist on the electronic device 100 from the time of shipment for basic functions (for example, an incoming and outgoing call function and a message reception and transmission function) of the electronic device 100. Meanwhile, the application program may be stored in the memory 170 and installed on the electronic device 100, and thus may be driven by the control unit 180 to perform the operation (or function) of the electronic device.

In addition to the operation related to the application program, the control unit 180 typically controls the overall operation of the electronic device 100. The control unit 180 may provide or process appropriate information or a function for a user by processing signals, data, information, and the like, which are input or output through the above-described components, or by driving the application program stored in the memory 170.

In addition, the control unit 180 may control at least some of the components described with reference to FIG. 1 to drive the application program stored in the memory 170. In addition, the control unit 180 may operate at least two or more of the components included in the electronic device 100 in combination with each other to drive the application program.

The power supply unit 190 receives power from an external power supply and an internal power supply under the control of the control unit 180 and supplies the received power to each component included in the electronic device 100. The power supply unit 190 includes a battery, which may be a built-in battery or a replaceable type battery.

At least some of the components may operate in cooperation with each other in order to implement an operation, control, or a control method of the electronic device according to various embodiments to be described below. In addition, the operation, control, or control method of the electronic device may be implemented on the electronic device by driving at least one application program stored in the memory 170.

In this specification, the electronic device 100 may be collectively referred to as an electronic device, and may include an abnormal transaction tracking device.

Abnormal transactions occurring in e-commerce in the present specification may include fraud, illegal product sales, cross trading, etc., all of which may be stored as data in an e-commerce server, and the abnormal transaction tracking device (electronic device) may track a user (abnormal user) who accesses the e-commerce server and parses data to perform the abnormal transactions.

The transaction information may include product information, payment information, delivery information, and user information.

The product information may include a product name and a product image, the payment information may include account information and card information, the delivery information may include a delivery address and a postal code, and the user information may include seller information and buyer information, including a seller or buyer's name, contact information, access device identity (ID) (device unique identification information), device model, access Internet protocol (IP) address, and location information.

The access IP address included in the user information may be a fixed IP excluding IP addresses and public facility IPs that are assigned by telecommunication companies. Accordingly, since the access IP address included in the transaction information is an IP address used by a small number of people at home or at work, when IP addresses of a plurality of transaction information overlap, it may be determined that a seller or a buyer performing the transaction is suspicious.

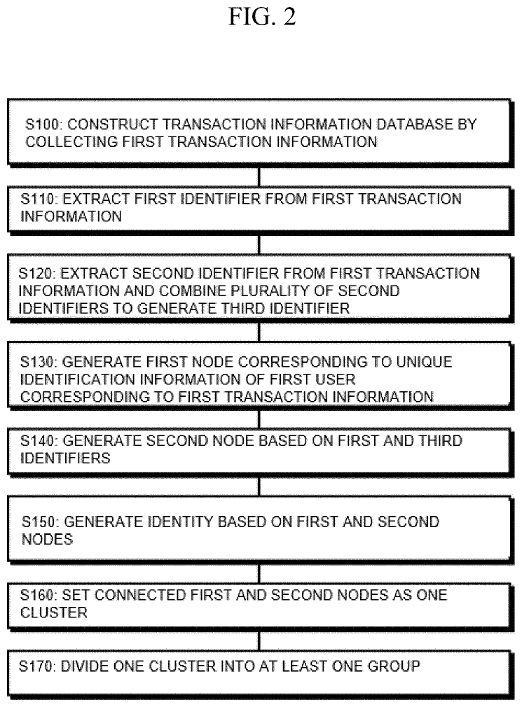

FIG. 2 is an example of a method of constructing an identity map used for a method of detecting an abnormal transaction applicable to the present specification.

Referring to FIG. 2, the electronic device may collect a plurality of pieces of first transaction information pre-stored in the e-commerce server to construct a transaction information database (S100).

For example, in constructing the transaction information database, the electronic device may crawl a website for a first product image included in the first transaction information to further collect an image related to a first product corresponding to the first product information.

Also, the electronic device may further include an image related to the collected first product as the first product image to construct the transaction information database.

The first transaction information stored in the transaction information database included in the e-commerce server may include a tag according to the presence or absence of an abnormal transaction. In more detail, the first transaction information previously determined to be an abnormal transaction may include an abnormal transaction tag.

The electronic device may further store, in the transaction information database, dangerous IP information about an IP address reported or blocked as fraud by a user of an e-commerce transaction. The electronic device may collect additional information such as an IP owner organization, country, and classless inter-domain routing (CIDR) for the reported IP address and further include the collected additional information in the dangerous IP information.

The electronic device extracts at least one first identifier from the first transaction information stored in the transaction information database (S110). For example, the first identifier may include payment information and/or user information (e.g., device ID, user ID, etc.) that is difficult for a user to arbitrarily change.

The electronic device extracts a second identifier different from the first identifier from the first transaction information, and combines the plurality of second identifiers to generate a third identifier (S120). In more detail, the electronic device may extract the second identifier by using the remaining transaction information except for the transaction information used to extract the first identifier from the information included in the transaction information.

For example, since, unlike the first identifier, the second identifier is extracted as information that may be arbitrarily modified by a user, the second identifier alone is difficult to use to determine abnormal users, and as a result, the plurality of second identifiers may be combined to be used as a sufficient basis for determining the abnormal users.

In more detail, the electronic device may combine the plurality of second identifiers extracted from a postal code, delivery address information, contact information, a name, the last four digits of the contact information, and the like to generate the third identifier.

Although manipulation is highly likely to be performed on the second identifier, when a postal code and a delivery address are set far from a user's main residence, since it is necessary to spend the cost of picking up traded products, by determining that the probability of manipulation is low and combining other second identifiers to generate a third identifier, the generated third identifier may be used as a basis for determining an abnormal user. Also, the electronic device may further set, as a fourth identifier, an identifier that is not defined as the third identifier among the second identifiers.

The electronic device may normalize first address information before using the first address information included in the first transaction information as the second identifier. Since any one of a street name address and a lot number address is used depending on a user, the unity of the address information is lowered, and thus the electronic device may convert the lot address into the street name address when the address information is the lot number address. In addition, the electronic device may remove unnecessary characters, symbols, and blanks included in a detailed address and unify a format of the detailed address through a hyphen. For example, when the detailed address is building no. 101 room no. 307 and building B room no. 3, the electronic device may unify the detailed addresses as 101-307 and B-3, respectively.

The electronic device generates a first node corresponding to the unique identification information of the first user included in the first transaction information (S130).

The electronic device generates the second node based on the first identifier and/or the third identifier extracted from the first transaction information (S140).

For example, the first node and the second node may be connected by an edge. As a result, the identity map may be configured around a node for the user's unique identification information.

The electronic device generates the identity map using the first node and the second node (S150). For example, when the second node connected to another first node b is the same as the first node a, the electronic device may connect nodes like first node a-second node-first node b. In this case, the electronic device may determine that the first node a and the first node b use different unique identification information from the same user.

Also, when generating the identity map, the electronic device may set a distance of an edge between the first node and the second node.

For example, the electronic device may set the distance of the edge between the first node and the second node corresponding to the first identifier to be zero. Accordingly, when there are a plurality of first nodes connected to the second node, a distance of an edge between the plurality of first nodes may be set to be 0.

In addition, the electronic device may use a set value of a manager for the third identifier when setting the distance of the edge between the first node and the second node corresponding to the third identifier. For example, the electronic device may set a distance of an edge between the second node corresponding to the third identifier having sufficient grounds to determine the risk level of the transaction information and the first node to be 1, and set a distance of an edge between the second node corresponding to the fourth identifier and the first node to be 2.

Also, the electronic device may differentiate the first node and the second node for the first transaction information including the abnormal transaction tag from the first node and the second node for the first transaction information that does not include the abnormal transaction tag. For example, the electronic device may change a color or size of the node corresponding to the first transaction information including the abnormal transaction tag.

The electronic device sets all connected first and second nodes as one cluster (S160). Accordingly, the identity map may include at least one cluster.

The electronic device divides the cluster into at least one group (S170). For example, the electronic device may set a set of the first nodes belonging to the cluster and the second nodes corresponding to the first identifier as a first group, set a set of the first nodes and the second nodes corresponding to the third identifier as the first group, and set a set of the first nodes and the second nodes corresponding to the fourth identifier as a third group.

That is, the electronic device may set the second node, in which the distance of the edge from the first node is 0, as the first group, the second node, in which the distance of the edge from the first node is 1, as the second group, and the second node, in which the distance of the edge from the first node is 2, as the third group.

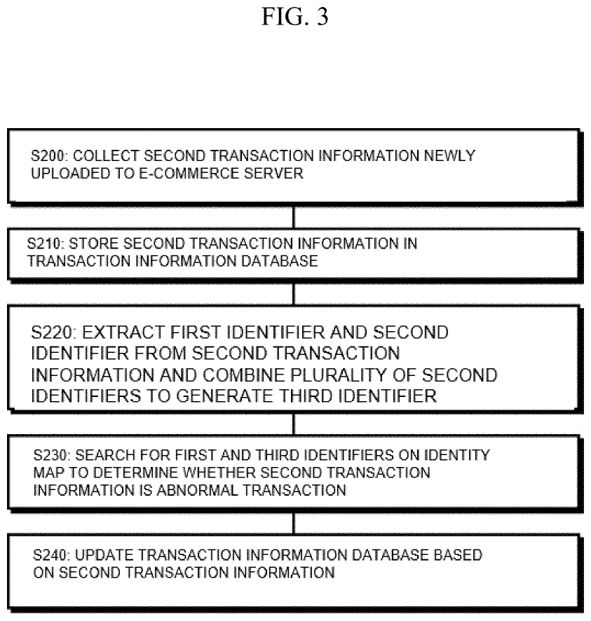

FIG. 3 is a flowchart for describing the method of detecting abnormal transactions applicable to the present disclosure.

Referring to FIG. 3, the electronic device may detect abnormal transactions using the identity map constructed in FIG. 2.

The electronic device collects second transaction information newly uploaded to the e-commerce server (S200). For example, the electronic device may follow a conventional technique in collecting the second transaction information. The second transaction information may be classified into states of before a transaction, during a transaction, and a transaction completion.

For example, newly uploaded second transaction information on the state of before the transaction may include only second product information and second user information (seller), and the second transaction information on the state during the transaction may include second product information, second payment information, second delivery information, and second user information (seller and buyer). When the second payment information, the second delivery information, and the second user information corresponding to the second transaction information in which the transaction has not been performed are additionally received, the electronic device may change the state of the second transaction information to the state during the transaction.

The electronic device may store the second transaction information in the transaction information database (S210).

The electronic device extracts the first identifier and the second identifier included in the second transaction information, and combines the plurality of second identifiers to generate the third identifier (S220).

As described above in FIG. 2, the first identifier may be information that is difficult for a user to arbitrarily change, the second identifier may be an identifier excluding the first identifier, and the third identifier may be a combination of the plurality of second identifiers.

In order to determine whether the second transaction information is generated by an abnormal user, the electronic device searches for the first identifier and the third identifier in the identity map to determine whether the second transaction information is an abnormal transaction (S230).

Since the method of detecting an abnormal transaction according to the embodiment of the present disclosure includes complexly analyzing the abnormal transaction using various identifiers, it will be difficult for an abnormal user to avoid detection of the abnormal transaction.

Hereinafter, a method of determining whether the second transaction information is the abnormal transaction by searching for each of the first identifier and the third identifier included in the second transaction information in the identity map will be described in more detail below.

1) First Identifier

The first identifier according to the embodiment of the present disclosure may include a device ID and payment information. For example, when the state of the second transaction information is before transaction, the first identifier will be a device ID, and when the state of the second transaction information is during transaction and transaction completion, the first identifier may include a device ID and payment information of the second user (second seller and second buyer).

The electronic device searches for the first identifier in the identity map, and when the second node corresponding to the first identifier is in the identity map, it may be determined through the color or size of the second node that the first transaction information corresponding to the second node includes an abnormal transaction tag. When the corresponding second node is related to the abnormal transaction, the electronic device may determine that a user (second seller or second buyer) corresponding to the second transaction information is an abnormal user. In this case, since the second node corresponding to the first identifier belongs to the first group of the identity map, the electronic device may block the second transaction information and the second user determined to be an abnormal user.

For example, when the first identifier includes the device IDs of both the second seller and the second buyer, the electronic device may further identify whether the second node corresponding to the second seller and the second buyer is in the same cluster. When it is determined that the second node corresponding to the second seller and the second buyer is in the same cluster, the electronic device may determine the second transaction information as cross trading and block the second transaction information.

2) Second Identifier

The third identifier according to the embodiment of the present disclosure is a combination of the plurality of second identifiers of delivery information including a delivery address and a postal code, a name, contact information, an access IP address, and location information, and may depend on a combination of the second identifiers set by a manager. The fourth identifier is an identifier that is not selected as the third identifier among the second identifiers. The third identifier and the fourth identifier may also not include specific identifiers according to the state of the third transaction information.

The electronic device searches for the third identifier in the identity map, and when the second node corresponding to the third identifier is present in the identity map, it may be determined that the second user (second seller or second buyer) corresponding to the second transaction information is highly likely to be an abnormal user. As the second node corresponding to the third identifier belongs to the second group, the electronic device may provide a notification to a manager terminal and a user, who is not determined to be an abnormal user, among the third seller and the third buyer who are third users.

In addition, the electronic device searches for the fourth identifier in the identity map, and when the second node corresponding to the fourth identifier is present in the identity map, it may be determined that the second user (second seller or second buyer) corresponding to the second transaction information is highly likely to be an abnormal user. As the second node corresponding to the fourth identifier belongs to the third group, the electronic device may track transaction progress of the third user who is likely to be an abnormal user and provide the tracked transaction progress to the manager terminal so that the manager may monitor the transaction progress of the third user.

For example, the second transaction information includes the second user information about a seller A and a buyer B, and when the electronic device determines that the seller A is an abnormal user based on the second user information, the electronic device may provide a notification to a terminal of the buyer B among the second users and the manager terminal.

Access IP Address

Meanwhile, according to another embodiment of the present disclosure, the electronic device may further search for a second access IP address included in the second user information in the transaction information database. When the access IP address included in the second user information is the same as a dangerous IP address stored in the abnormal transaction database or uses the same band range as a dangerous IP address, the electronic device may determine that the second transaction information is generated in the IP band mainly used by abnormal users and block the second transaction information.

Dark Web Exposure

In addition, the electronic device may access a dark web based on a name, contact information, etc., included in the second user information and determine whether the name, the contact information, etc., have been exposed to an abnormal user. When the name and contact information included in the second user information are exposed to the dark web, the electronic device may block the second transaction information.

Product Image Theft

Meanwhile, the electronic device according to another embodiment of the present disclosure may identify a feature area from a second product image of the second transaction information and extract a feature descriptor of the second product image. The feature area is a main area for extracting a descriptor for a feature of images, that is, a feature descriptor for determining whether the images are identical or similar, and the feature descriptor will express the features of the second product image as vector values.

The feature area according to the embodiment of the present disclosure may be contours included in an image, corners among the contours, a blob distinguished from a peripheral area, an area that does not change or that changes according to the deformation of the image, or a pole that is darker or brighter than the ambient light.

The electronic device may calculate the feature descriptor by using a location of the feature area for the second product image, or brightness, color, sharpness, gradient, scale, or pattern information of the feature area. For example, the feature descriptor may convert a brightness value of a feature area, a change value or a distribution value of brightness, or the like into vectors and may be calculated.

The electronic device may determine whether the same first product image as the second product image is stored in the transaction information database based on the feature descriptor of the second product image.

When the same first product image as the second product image is present in the product information database, the electronic device may determine the second product image as a stolen image and block the second transaction information.

Referring back to FIG. 3, the electronic device updates the transaction information database based on the second transaction information (S240). Specifically, the electronic device may update the transaction information database by adding a tag indicating the abnormal transaction to the second transaction information that is determined to be an abnormal transaction and is blocked.

Thereafter, the electronic device may update the identity map based on the second transaction information. Specifically, the electronic device may further expand the identity map by generating the second node corresponding to the first identifier and the third identifier of the second transaction information and connecting the second node to the first node for the second user of the second transaction information.

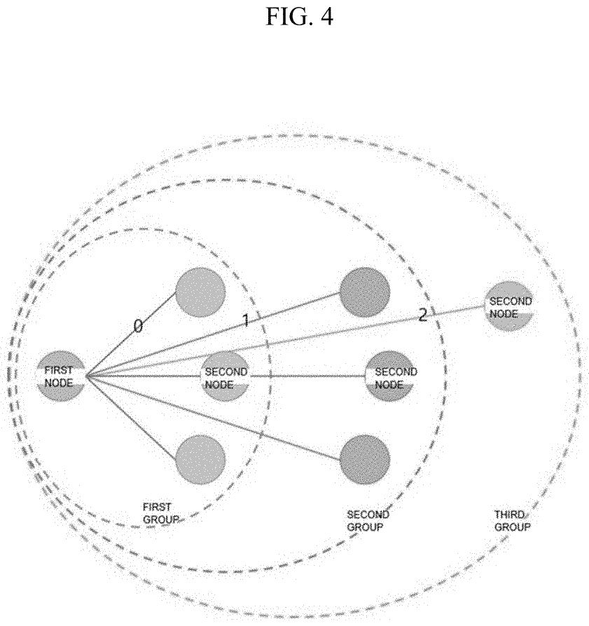

FIG. 4 is an example of the identity map applicable to the present disclosure.

Referring to FIG. 4, the electronic device may construct the identity map according to the method of FIG. 2 described above.

For example, the electronic device may detect an abnormal transaction using the identity map of FIG. 4 according to the method of FIG. 3.

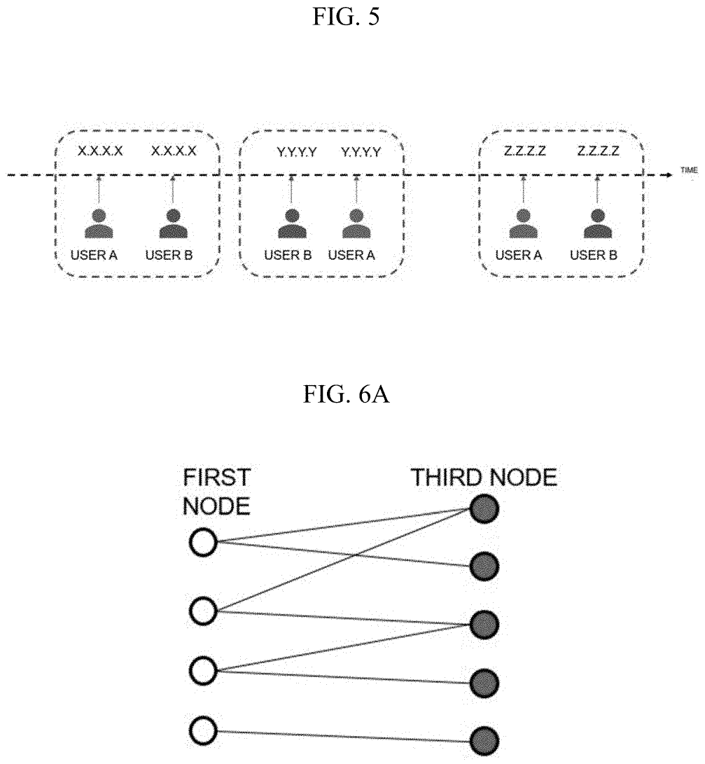

FIG. 5 is an example of an access IP address pattern applicable to the present disclosure.

As described above, the transaction information may include user information, the user information may include an access IP address of a seller or a buyer, and the access IP address may be a fixed IP address.

The electronic device may detect accounts accessed multiple times by the same IP address during a specific period from transaction information included in the e-commerce server.

Referring to FIG. 5, when three IP addresses (X.X.X.X, Y.Y.Y.Y, Z.Z.Z.Z) are used only by a user A and a user B, and records accessed by the two users at a similar time are above a certain value, the electronic device may determine that users A and B have the same identity.

For example, in order to determine whether different users have the same identity, the electronic device may manage a user's access history for each IP address.

Table 1 below is an example of user access history data of an IP address (x.x.x.x).

TABLE 1

| User ID | Month | Week |
|---|---|---|
| 300 | 3 | 1 |
| 500 | 3 | 2 |
| 300 | 3 | 2 |
| 300 | 3 | 3 |
| 500 | 7 | 1 |
| 500 | 7 | 2 |
| 300 | 7 | 4 |

Referring to Table 1, the electronic device may generate and periodically update data for checking the user access history for each IP address.

For example, the electronic device may check that a user 300 accesses X.X.X.X in the 1st to 3rd weeks of March and a user 500 accesses X.X.X.X in the 2nd week of March, and may check that the user 500 accesses X.X.X.X in the 1st and 2nd weeks of July and the user 300 accesses it in the 4th week of July.

When an access period of another user ID of the same IP set in the electronic device is within two weeks and the number of detections within the access period is twice or more, the users 300 and 500 may be considered to have the same identity.

Also, through the transaction information database, the electronic device may detect accounts using IP addresses accessed by users who have previously attempted abnormal transactions, and accounts using known malicious IPs, specific country IP bypasses, and the like.

As a result, by comparing the detected account with the accessing user, the electronic device may check whether accesses of users who attempt abusive acts through IP manipulation and bypassing are being attempted. In addition, the electronic device may detect whether users are malicious users by checking and matching IP ownership organizations that the malicious users intensively use.

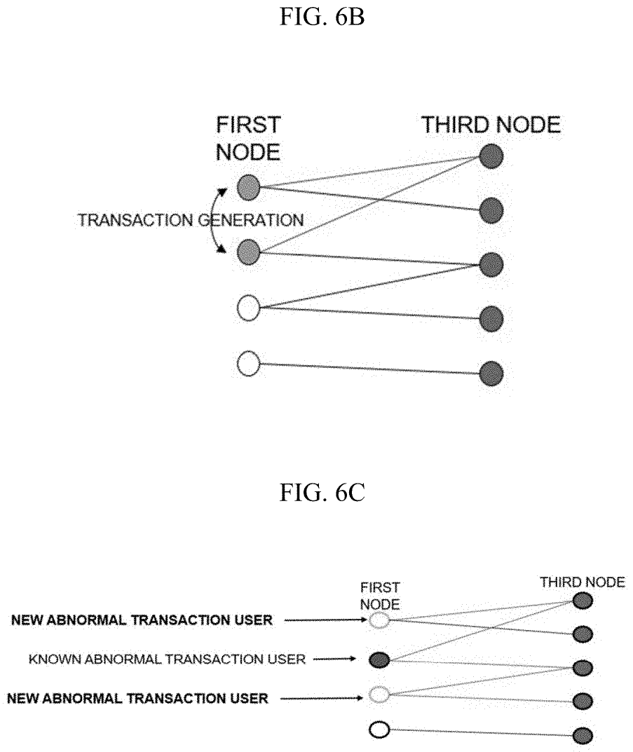

FIGS. 6A, 6B and 6C shows examples of an automatic detection algorithm to which the present disclosure may be applied.

Referring to FIG. 6A, the electronic device may generate a third node corresponding to an access IP address in addition to the above-described identity map, and connect the corresponding first node. As in S160 described above, the third node may be included in the same cluster as the connected first node.

Referring to FIG. 6B, when the first node corresponding to the seller participating in the transaction and the first node corresponding to the buyer are included in the same cluster, the electronic device may determine that the transaction is cross trading. That is, from the point of view of the third node, being included in the same cluster may indicate access to the same IP address.

Referring to FIG. 6C, the electronic device may reversely track the third node connected to the first node corresponding to the already known abnormal transaction user to detect the first node corresponding to a new abnormal transaction user included in the same cluster.

It goes without saying that the method of detecting an abnormal transaction of FIG. 3 may be equally applied to the automatic detection algorithm illustrated in FIG. 6.

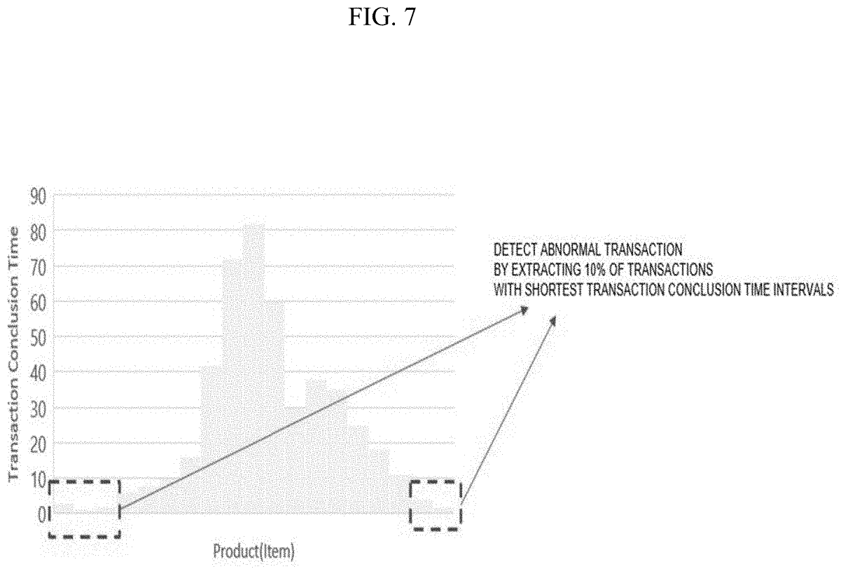

FIG. 7 is an example of a transaction conclusion time analysis to which the present disclosure may be applied.

Referring to FIG. 7, since a time interval between sale and purchase may be short in order to succeed in the transaction in the case of cross trading, the electronic device may extract, for example, 10% of transactions with the shortest transaction conclusion time intervals to detect abnormal transactions.

For example, a transaction with a short conclusion interval (time interval between sales/purchase for each product (item)) may be extracted.

Also, the electronic device may analyze a transaction proportion in consideration of a conclusion period (short interval among recent transactions between users).

For example, when most of a user A′s total transactions are transactions with a user B, a transaction between the two may be suspected as an abnormal transaction. When the total number of transactions of A and B/the total number of transactions of A is greater than or equal to a specific value (e.g., 0.9), the electronic device may detect that there are abnormal transactions. To this end, the electronic device may use the above-described history data.

As a result, the electronic device may reduce the cost required for detection.

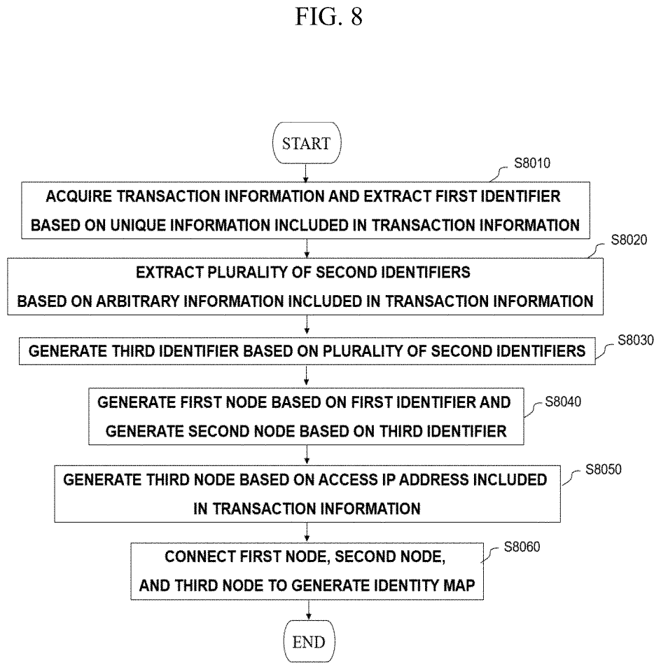

FIG. 8 is an embodiment of the electronic device to which the present disclosure may be applied.

Referring to FIG. 8, the electronic device may generate the above-described identity map in a memory, and detect an abnormal transaction using the above-described examples based on the generated identity map.

Also, the electronic device may communicate with the e-commerce server through the communication module.

The electronic device obtains the transaction information from the e- commerce server and extracts the first identifier based on unique information included in the transaction information (S8010). For example, the unique information may include a user ID as user information that is difficult for a user to arbitrarily change.

The electronic device extracts the plurality of second identifiers based on arbitrary information included in the transaction information (S8020). For example, the arbitrary information is information that a user may arbitrarily change, and may include a name, contact information, location information, and the like.

The electronic device generates the third identifier based on the plurality of second identifiers (S8030).

The electronic device generates the first node based on the first identifier, and generates the second node based on the third identifier (S8040). For example, the electronic device may generate the first node corresponding to the first identifier and may generate the second node corresponding to the third identifier.

The electronic device generates the third node based on the access IP address included in the transaction information (S8050). For example, the electronic device may generate the third node corresponding to the access IP address.

The electronic device generates the identity map for detecting abnormal transactions by connecting the first node, the second node, and the third node (S8060).

Thereafter, the electronic device classifies a cluster based on the identity map. For example, the cluster may be a set of connected nodes.

The electronic device may detect abnormal transactions based on the cluster.

For example, when different first nodes connected to the third node are present, the electronic device may determine that there are abnormal transactions.

In addition, the electronic device may communicate with the e-commerce server to monitor access histories of users and generate history data as shown in Table 1 above. The electronic device may detect abnormal transactions based on the history data.

For example, the electronic device may count the number of transactions between different users by using the history data, and as described above, when the number of transactions between different users is greater than or equal to a specific ratio of the number of individual transactions, the electronic device may determine that there are abnormal transactions.

The present disclosure described above can be embodied as a computer readable code on a medium on which a program is recorded. Computer readable media may include all kinds of recording devices in which data that may be read by a computer system is stored. Examples of the computer readable medium may include a hard disk drive (HDD), a solid state disk (SSD), a silicon disk drive (SDD), a read only memory (ROM), a random access memory (RAM), a compact disc read only memory (CD-ROM), a magnetic tape, a floppy disk, an optical data striate, or the like, and also include a medium implemented in the form of carrier waves (for example, transmission through the Internet). Therefore, the above-described detailed description is to be interpreted as being illustrative rather than being restrictive in all aspects. The scope of the present disclosure is to be determined by reasonable interpretation of the claims, and all modifications within an equivalent range of the present disclosure fall in the scope of the present disclosure.

According to an embodiment of the present disclosure, it is possible to configure a method and apparatus for automatically detecting an abnormal transaction by detecting accounts expected to be the same through a user's access IP address pattern.

In addition, according to an embodiment of the present disclosure, it is possible to configure a method and apparatus for automatically detecting an abnormal transaction by analyzing a transaction pattern such as a transaction conclusion time and a transaction proportion.

Effects which may be achieved by the present disclosure are not limited to the above-described effects, and other objects that are not described may be obviously understood by those skilled in the art to which the present disclosure pertains from the following description.

In addition, although services and embodiments have been mainly described hereinabove, this is only an example and does not limit the present disclosure. Those skilled in the art to which the present disclosure pertains may understand that several modifications and applications that are not described in the present disclosure may be made without departing from the essential characteristics of the present services and embodiments. For example, each component described in detail in the embodiments may be modified. In addition, differences associated with these modifications and applications are to be interpreted as being included in the scope of the present disclosure as defined by the following claims.

What is claimed is:

1. A method of automatically detecting, by an electronic device, an abnormal transaction, comprising:
acquiring transaction information from an e-commerce server, the transaction information including unique information that is difficult for a user to arbitrarily change, arbitrary information that a user changes arbitrarily, and an access Internet protocol (IP) address;
extracting a first identifier based on the unique information;
extracting a plurality of second identifiers based on the arbitrary information;
generating a third identifier based on the plurality of second identifiers;
generating a first node based on the first identifier and generating a second node based on the third identifier;
generating a third node based on the access IP address; and
connecting the first node, the second node, and the third node to generate an identity map for automatically detecting the abnormal transaction.

2. The method of claim 1, further comprising classifying a cluster based on the identity map,
wherein the cluster includes a set of connected nodes.

3. The method of claim 2, further comprising detecting the abnormal transaction based on the cluster;

4. The method of claim 3, wherein the detecting of the abnormal transaction based on the cluster includes determining the abnormal transaction when different first nodes connected to the third node are present.

5. The method of claim 3, wherein the detecting of the abnormal transaction based on the cluster includes:
monitoring a user's access history through the e-commerce server; and
generating history data for each access IP address based on the monitoring result and the cluster, the history data including an identifier of the user and an access time of the user.

6. The method of claim 5, wherein the detecting of the abnormal transaction based on the cluster further includes determining the abnormal transaction when the number of transactions between the different first nodes is greater than or equal to a specific ratio of the number of individual transactions.

7. An electronic device for automatically detecting an abnormal transaction, comprising:
a communication module;
a memory; and
a processor that functionally controls the communication module and the memory,
wherein the processor acquires transaction information from an e-commerce server, the transaction information including unique information that is difficult for a user to arbitrarily change, arbitrary information that a user changes arbitrarily, and an access Internet protocol (IP) address, extracts a first identifier based on the unique information, extracts a plurality of second identifiers based on the arbitrary information, generates a third identifier based on the plurality of second identifiers, generates a first node based on the first identifier and generates a second node based on the third identifier, generates a third node based on the access IP address, and connects the first node, the second node, and the third node to generate an identity map for automatically detecting the abnormal transaction.
